(19) United States
(12) Patent Application Publication
(10) Pub. No.: US 2020/0230628 A1
(43) Pub. Date: Jul. 23, 2020

(54) ELECTROSTATIC SPRAYING DEVICE

(71) Applicant: ANEST IWATA Corporation, Kanagawa (JP)

(72) Inventors: Kazuaki SATO, Kanagawa (JP); Shoji KAKIZAKI, Kanagawa (JP)

(21) Appl. No.: 16/652,811

(22) PCT Filed: Oct. 17, 2017
(86) PCT No.: PCT/JP2017/037531

§ 371 Date: Apr. 1, 2020

(51) Int. Cl. B05B 5/035; B05B 5/10; B05B 5/053

(52) U.S. Cl. CPC B05B 5/035; B05B 5/0533; B05B 5/10

(57) ABSTRACT

Provided is an electrostatic spraying device capable of spraying liquid, such as paint, onto a sprayed object in a stable manner. The electrostatic spraying device of the invention releases liquid in an electrically-charged state from a nozzle using an electrostatic force generated by voltage application and thus sprays the liquid onto a sprayed object. The electrostatic spraying device comprises a nozzle head provided with the nozzle comprising a plurality of nozzles made of conductive or semiconductive material and a voltage application device configured to apply voltage between the nozzles and a heteropolar portion (sprayed object) that is heteropolar to the nozzles and thus generate the electrostatic force. The nozzles are so arranged that distance between axes L of at least adjacent nozzles increases with increasing distance from the nozzle head.

### TECHNICAL FIELD

The invention relates to electrostatic spraying devices.

### BACKGROUND ART

Patent Literature 1 discloses a spray nozzle device (electrostatic spraying device). This spray nozzle device includes a plurality of nozzles arranged in a pattern of radially layered circles. The plurality of nozzles spray liquid droplets which are electrostatically charged to collect particulate matter in an air stream.

The nozzles located closer to the center are protruding more to achieve a uniform spray distribution pattern.

### CITATION LIST

### Patent Literature

PTL 1: Japanese Unexamined Patent Application Publication (Kohyo) No. 2008-516766

### SUMMARY OF INVENTION

### Technical Problem

Even the spray nozzle device configured as disclosed in Patent Literature 1 sometimes fails to perform stable spraying, for example, as in a case where the sprayed liquid droplets vary in particle diameter and other like cases. Such unstable spraying does not matter too much in the case like Patent Literature 1 where the liquid spraying is applied to a dust collector for collecting particle matter in an air stream because the dust collector is merely intended to create liquid droplets having sufficiently small particle diameter. When liquid, such as paint, is applied onto a sprayed object, however, a spray nozzle device is desirably capable of spraying the liquid in a more stable manner to repress uneven application of the liquid.

The invention has been made in light of the foregoing circumstances and is designed to provide an electrostatic spraying device that is capable of spraying liquid, such as paint, onto a sprayed object in a stable manner.

### Solution to Problem

One embodiment of the invention may be configured as below.

(1) According to one embodiment of the invention, an electrostatic spraying device which releases liquid in an electrically-charged state from a nozzle using an electrostatic force generated by voltage application and thus sprays the liquid onto a sprayed object comprises a nozzle head provided with the nozzle comprising a plurality of nozzles made of conductive or semiconductive material and a voltage application device configured to apply voltage between the nozzles and a heteropolar portion that is heteropolar to the nozzles and thus generate the electrostatic force. The nozzles are so disposed that distance between axes of at least adjacent nozzles increases with increasing distance from the nozzle head.

(2) According to the configuration described under (1), the nozzles are so disposed that distance between axes of all the nozzles increases with increasing distance from the nozzle head.

(3) According to one embodiment of the invention, an electrostatic spraying device which releases liquid in an electrically-charged state from a nozzle using an electrostatic force generated by voltage application and thus sprays the liquid onto a sprayed object comprises a nozzle head made of insulating material, which is provided with the nozzle comprising a plurality of nozzles made of conductive or semiconductive material, and a voltage application device configured to apply voltage between the nozzles and a heteropolar portion that is heteropolar to the nozzles and thus generate the electrostatic force. The nozzles are protruding from the nozzle head. The electrostatic spraying device includes a plurality of electrode portions that are disposed near root portions on nozzle head sides of the nozzles protruding from the nozzle head so as to coincide with the plurality of nozzles. The electrode portions have the same electric potential as the nozzles.

(4) According to one embodiment of the invention, an electrostatic spraying device which releases liquid in an electrically-charged state from a nozzle using an electrostatic force generated by voltage application and thus sprays the liquid onto a sprayed object comprises a nozzle head made of insulating material, which is provided with the nozzle comprising a plurality of nozzles made of conductive or semiconductive material, and a voltage application device configured to apply voltage between the nozzles and a heteropolar portion that is heteropolar to the nozzles and thus generate the electrostatic force. The nozzles are protruding from the nozzle head. The electrostatic spraying device includes a single electrode portion that is disposed near root portions on nozzle head sides of the nozzles protruding from the nozzle head so as to coincide with all the nozzles. The electrode portion has the same electric potential as the nozzles.

(5) According to one embodiment of the invention, an electrostatic spraying device which releases liquid in an electrically-charged state from a nozzle using an electrostatic force generated by voltage application and thus sprays the liquid onto a sprayed object comprises a nozzle head made of insulating material, which is provided with the nozzle comprising a plurality of nozzles made of conductive material, and a voltage application device configured to apply voltage between the nozzles and a heteropolar portion that is heteropolar to the nozzles and thus generate the electrostatic force. The nozzles includes root portions on nozzle head sides of the nozzles protruding from the nozzle head, which are formed larger in outer shape than distal end portions of the nozzles.

(6) According to the configuration described under (5), the root portions of the nozzles are formed larger in outer shape than the distal end portions of the nozzles so that distance between the root portions of adjacent ones of the nozzles is 5 mm or less.

(7) According to the configuration described under any one of (1) to (6), the nozzles are arranged along a width direction of the nozzle head.

According to one embodiment of the invention, an electrostatic spraying device is provided, which is capable of spraying liquid, such as paint, onto a sprayed object in a stable manner.

### BRIEF DESCRIPTION OF DRAWINGS

FIG. 1 is a perspective view of an electrostatic spraying device according to a first embodiment of the invention.

FIG. 2 is a top view of the electrostatic spraying device according to the first embodiment of the invention as viewed from above.

FIG. 3 is a cross-section along line A-A of FIG. 2.

FIG. 4 is a plan view for explaining liquid spraying performed by the electrostatic spraying device according to the first embodiment of the invention.

FIG. 5 is a perspective view of an electrostatic spraying device according to a second embodiment of the invention.

FIG. 6 is a plan view for explaining an electrostatic spraying device according to a third embodiment of the invention.

FIG. 7 is a perspective view for explaining an electrostatic spraying device according to a fourth embodiment of the invention.

### DESCRIPTION OF EMBODIMENTS

Embodiments for carrying out the invention (hereinafter, referred to as embodiments) will be discussed in detail with reference to the attached drawings. Same elements are provided with same reference signs throughout the description of the embodiments.

Unless otherwise noted, “distal (end),” “front (frontward)” and other like terms refer to a side of each member and the like, which faces a direction in which liquid is sprayed, and “rear (end),” “rear (rearward)” and other like terms refer to an opposite side of each member and the like, which faces opposite to the liquid spraying direction.

### First Embodiment

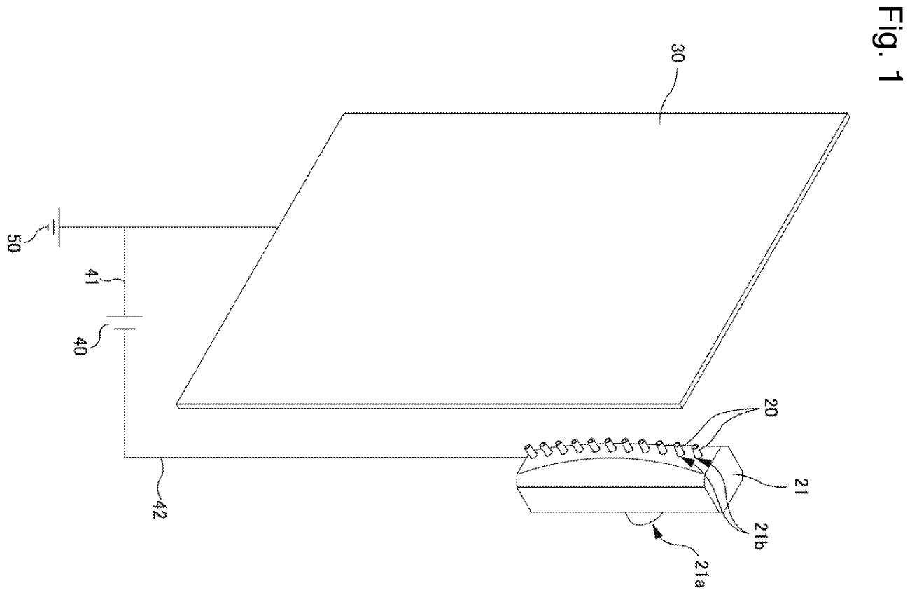

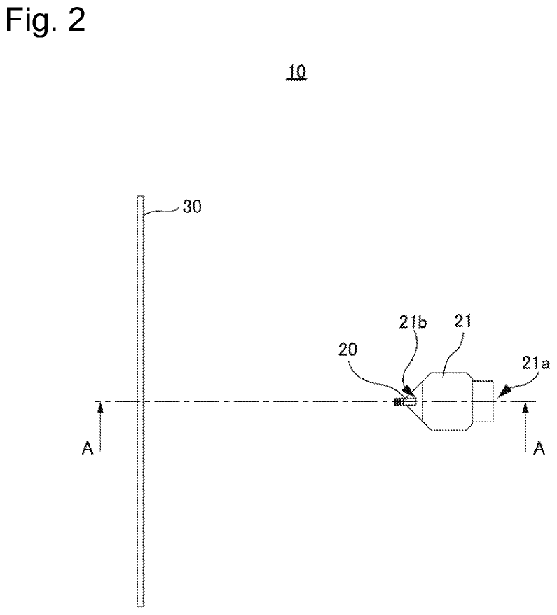

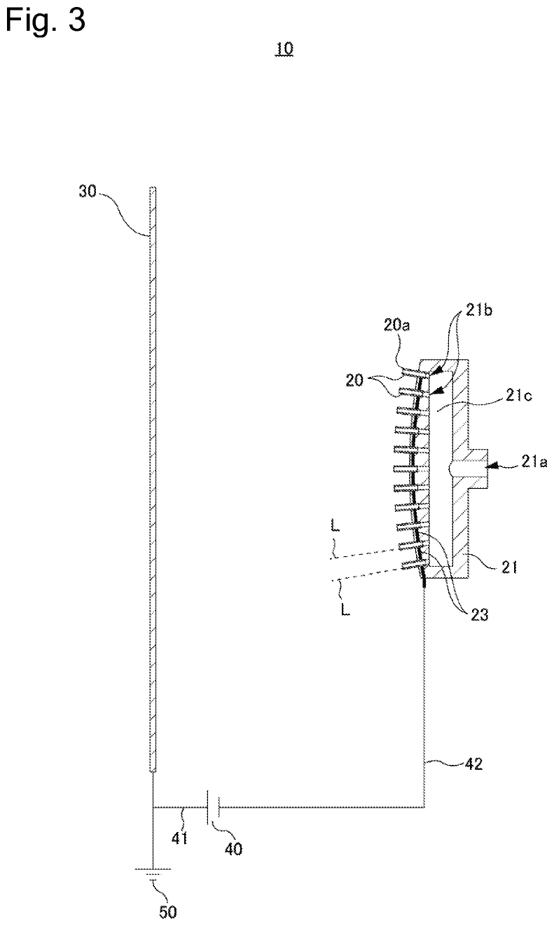

FIG. 1 is a perspective view of an electrostatic spraying device 10 according to a first embodiment of the invention. FIG. 2 is a top view of the electrostatic spraying device 10 as viewed from above. FIG. 3 is a cross-section along line A-A of FIG. 2.

FIG. 2 omits a voltage application device 40.

As illustrated in FIG. 3, the electrostatic spraying device 10 includes a nozzle head 21 and the voltage application device 40 (source voltage). The nozzle head 21 is provided with a plurality of nozzles 20 made of conductive material or semiconductive material (material having a surface resistance of 10¹⁰Ω or less). The voltage application device 40 applies voltage between a heteropolar portion (sprayed object 30) that is heteropolar to the nozzles 20 and the nozzles 20 and thus generates an electrostatic force.

According to the present embodiment, one electric line 41 extending from the voltage application device 40 is connected directly to the sprayed object 30, to thereby make the sprayed object 30 itself function as the heteropolar portion that is heteropolar to the nozzles 20. It is also possible, for example, to connect the one electric line 41 extending from the voltage application device 40 to a rested portion on which the sprayed object 30 is rested to use the rested portion as the heteropolar portion, and bring the sprayed object 30 into contact with the heteropolar portion so that the sprayed object 30 has the same electric potential as the heteropolar portion.

According to the present embodiment, the electrostatic spraying device 10 includes an earthing device 50 that earths or grounds the sprayed object 30. The earthing device 50 is not an essential element of the invention. Nevertheless, considering a possibility that an operator might touch the sprayed object 30, it is preferable to provide the earthing device 50 from a safety standpoint.

The nozzle head 21 includes a liquid supply inlet 21a through which liquid to be sprayed is supplied, and a liquid diverging portion 21c communicating with the liquid supply inlet 21a. The liquid diverging portion 21c has a plurality of liquid outlets 21b coinciding with the nozzles 20. The nozzles 20 are inserted and fastened in the liquid outlets 21b.

The liquid supply inlet 21a of the nozzle head 21 is connected to a liquid supply pipe extending from a liquid supply portion, not shown.

According to the present embodiment, as is apparent from FIG. 1, the nozzle head 21 has a rectangular shape as viewed straight from an object sprayed with the liquid. The nozzles 20 are located at a substantially center of the nozzle head 21 in a thickness direction (direction intersecting with a longitudinal direction) of the nozzle head 21 to be arranged or aligned in a width (longitudinal) direction of the nozzle head 21.

As illustrated in FIG. 3, an electric line 23 is embedded in the nozzle head 21 so that the nozzles 20 are electrically connected to one another after being inserted and fastened in the liquid outlets 21b. One end of the electric line 23 is connected to the other electric line 42 extending from the voltage application device 40.

According to the present embodiment, the nozzle head 21 is made of insulating material (such as insulating plastic material). The nozzle head 21 may be made of conductive material or semiconductive material (material having a surface resistance of 10¹⁰Ω or less).

If made of conductive material or semiconductive material (material having a surface resistance of 10¹⁰Ω or less), the nozzle head 21 itself functions as an electrode having the same electric potential as the nozzles 20 and is likely to generate sparks. It is then preferable that only the nozzles 20 be made of conductive material or semiconductive material (material having a surface resistance of 10¹⁰Ω or less) and that the nozzle head 21 be made of insulating material as in the present embodiment.

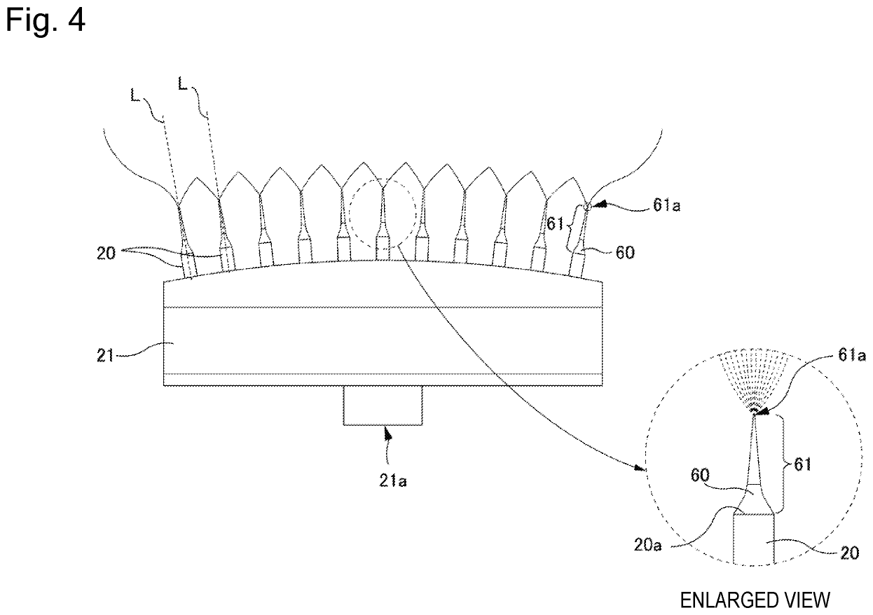

FIG. 4 is a plan view for explaining liquid spraying performed by the electrostatic spraying device 10.

When voltage is applied between the sprayed object 30 and the nozzles 20 by the voltage application device 40, an electrostatic force is generated between the sprayed object 30 and the nozzles 20. The liquid supplied to the nozzles 20 is electrically charged by the electrostatic force. More specifically, a surface of the liquid at a distal end of each of the nozzles 20 is electrically charged. As illustrated in FIG. 4, the electrically-charged liquid is pulled frontward by the electrostatic force and released from the nozzles 20 while remaining electrically charged.

To be more specific, as illustrated in an enlarged view of FIG. 4, when a balance is established between an adhesion force that is caused by surface tension and cohesion which attract the liquid to distal external edges 20a of the nozzles 20 and the electrostatic force pulling the liquid frontward, distal end portions of the liquid supplied to distal sides of the nozzles 20 protrude from the distal external edges 20a. The protruding portions of the liquid are formed into conical Taylor cones 60.

The Taylor cone 60 is formed as below. Due to an electric field effect, positive and negative charges are separated in the liquid, and a meniscus of the liquid at the distal end of each of the nozzles 20 is charged with excess charge. The meniscus is then deformed by the electric field effect into the Taylor cone 60 having a conical shape.

The liquid is pulled straight from a distal end of the Taylor cone 60 by the electrostatic force. The liquid is then sprayed as a result of an electrostatic burst.

In some cases, a line is unclear between the Taylor cone 60 and a portion of the liquid which is pulled straight from the Taylor cone 60 to extend frontward. As a whole, nevertheless, the liquid stretches frontward in a tapering fashion.

The sprayed liquid, or the liquid that is released from the nozzles 20 and turned into liquid particles, has air-exposed area that is remarkably larger than before being released from the nozzles 20, which expedites solvent vaporization. The solvent vaporization reduces distance between electrically-charged electrons to generate electrostatic repulsion (electrostatic burst). As a result, the liquid is further broken into liquid particles having smaller diameter.

When the liquid breakup happens, a surface area of the liquid exposed to air is further increased as compared to before the breakup. This expedites solvent vaporization and causes an electrostatic burst in a similar fashion to the foregoing. The liquid is thus broken into liquid particles having still smaller diameter.

Such electrostatic bursts are repeated to atomize the liquid.

The close arrangement of the plurality of nozzles 20 as in the present embodiment is like providing a single large electrode. Therefore, the electrostatic force acting on each of the nozzles 20 is small.

Therefore, the electrostatic force (tensile force) acting on the liquid that is pulled frontward from the nozzles 20 by the electrostatic force (a portion of the liquid from a time point the portion of the liquid is discharged from each of the nozzles 20 to a time point the electrostatic burst occurs is sometimes referred to as a liquid line 61) is small in an immediate vicinity of the nozzles 20. The electrostatic force acting on the liquid lines 61 increases with increasing distance from the nozzles 20.

The inventors have noted that if the liquid lines 61 are located close to each other, such arrangement makes it difficult for the electrostatic force at distal ends 61a of the liquid lines 61 to grow large even with increasing distance from the nozzles 20, and the electrostatic force does not act stably, which makes the electrically-charged state of the liquid lines 61 unstable and occasionally hinders a stable electrostatic burst.

In order to solve the aforementioned problem, the electrostatic force acting on the liquid lines 61 needs to be reinforced and yet stabilized by increasing distance between the liquid lines 61 as distance from the nozzles 20 increases. To that end, according to the present embodiment, the nozzles 20 are so disposed that distance between axes L of all the nozzles 20 increases as the axes L extend farther from the nozzle head 21 as illustrated in FIG. 4.

More specifically, an end face of the nozzle head 21 in which the nozzles 20 are disposed is formed into a curve. The nozzles 20 are arranged on the curved end face and oriented in a normal direction of the curve.

If the nozzles 20 are arranged this way, the electrostatic force is weak at the immediate outside of the nozzles 20, so that the liquid lines 61 are pulled by a small tensile force. The electrostatic force acting between the adjacent liquid lines 61 becomes less and less with increasing distance from the nozzles 20, and the electrostatic force strongly acts on the liquid lines 61. The liquid lines 61 are then pulled by a large tensile force to stretch into a tapered shape in a stable manner.

The tapering of the liquid lines 61 facilitates the action of the electrostatic force on the liquid lines 61. Furthermore, since the liquid lines 61 are pulled to be tapered, the electrostatic force concentrates in the distal end portion of the electrically-charged liquid, generating a repulsive force between the electrons existing on the liquid surface. This triggers the electrostatic burst to spray the liquid, leading to good atomization of the liquid.

As discussed above, if the liquid lines 61 are located close to each other, and the electrostatic force does not act strongly and stably on the distal ends 61a of the liquid lines 61, the electrically-charged state of the liquid is not stable, either. The electrostatic burst itself is unstable under such a state. It might be then impossible to achieve proper spraying.

It surprisingly seems that, when the liquid lines 61 stretch in the tapered shape as in the present embodiment, the distal ends 61a of the liquid stretching frontward make self-adjustment to be located at such positions that the electrostatic burst is evenly caused by changing the distal ends' positions where the electrostatic burst is caused in response to a change in the electrostatic force and the like caused by a change in voltage of the voltage application device 40, a change in moisture and the like. This enables the electrostatic spraying device 10 according to the present embodiment to perform more stable spraying.

### Second Embodiment

In the foregoing case, the nozzles 20 protrude frontward from the nozzle head 21. The nozzles 20, however, do not necessarily have to protrude. Instead, the distal ends of the nozzles 20 may be substantially flush with a front end face of the nozzle head 21.

It is still preferable that the nozzles 20 protrude from the nozzle head 21 if the nozzle head 21 is made of insulating material as described above.

For example, if liquid dripping from any of the nozzles 20 or the like occurs, and the liquid electrically connected to the nozzle 20 adheres to the nozzle head 21. The liquid then behaves as an electrode having the same electric potential as the nozzle 20, creating a state equivalent to a state where another electrode is provided on a surface of the nozzle head 21.

If the above situation occurs, the action of the electrostatic force on the nozzle 20 with the liquid dripping or the like becomes different from the action of the electrostatic force on the nozzles 20 without such liquid dripping or the like. Consequently, a spraying condition of the nozzle 20 with the liquid dripping or the like becomes different from a spraying condition of the other nozzles 20.

In contrast, if the nozzles 20 protrude from the nozzle head 21, even if the liquid dripping or the like occurs, the dripping liquid adheres to the nozzle 20, but not beyond an outer peripheral surface thereof. In this case, there is no portion of the liquid that behaves as another electrode on the surface of the nozzle head 21, which represses a change of the action of the electrostatic force on the nozzle 20.

It is therefore preferable that the nozzles 20 protrude from the nozzle head 21 if the nozzle head 21 is made of insulating material.

As discussed in the first embodiment, if the liquid lines 61 are formed to stretch in a stable manner, stable atomization is possible even if there is a change in voltage of the voltage application device 40 and a change in moisture or if coating material adheres to the nozzle head 21 made of insulating material.

In this view, a second embodiment refers to an electrostatic spraying device 10 that is incorporated with a configuration in which even if the liquid adheres to the surface of the nozzle head 21, a portion of the liquid is prevented from behaving as another electrode, which represses a change in action of the electrostatic force on the nozzles 20 and enables the liquid lines 61 to stretch in a more stable manner.

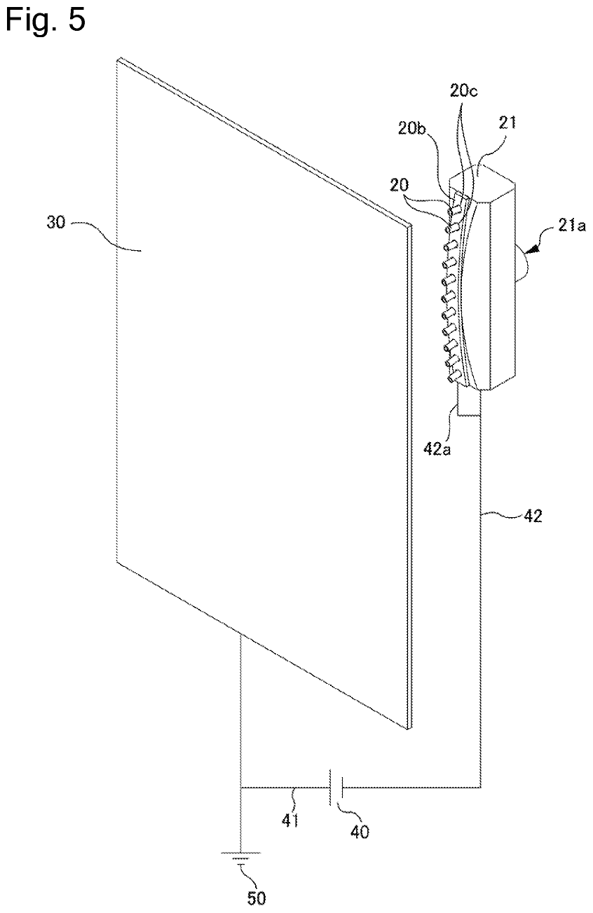

FIG. 5 is a perspective view of the electrostatic spraying device 10 according to the second embodiment.

As illustrated in FIG. 5, the electrostatic spraying device 10 of the second embodiment is similar to the first embodiment in basic configuration. The following description mainly discusses differences from the first embodiment and might omit a reference to similarities.

The electrostatic spraying device 10 according to the second embodiment has the configuration of the first embodiment into which an electrode portion 20b is incorporated. The electrode portion 20b is disposed near root portions on nozzle head 21-sides of nozzles 20 protruding from a nozzle head 21. The electrode portion 20b thus coincides with all the nozzles 20.

As illustrated in FIG. 5, an electric line 42a is connected to the electrode portion 20b. The electric line 42a branches off from the other electric line 42 that extends from a voltage application device 40 to be electrically connected to the nozzles 20. The electrode portion 20b has the same electric potential as the nozzles 20.

The electric line 42a may be omitted by forming the electrode portion 20b integrally with the plurality of nozzles 20 so that the electrode portion 20b is connected integrally with the nozzles 20.

With the electrode portion 20b thus formed, as described above, the concentration of an electrostatic force does not rise in the vicinity of the electrode portion 20b, so that the action of the electrostatic force becomes weak, and an electrostatic burst does not occur in the vicinity of the nozzles 20. Consequently, a large tensile force is applied to the liquid in such a direction that the liquid is pulled toward the sprayed object 30, making the liquid stretch frontward in a stable manner.

The electrostatic force acts on the liquid more strongly with increasing distance from the electrode portion 20b. The liquid therefore further stretches frontward in a tapering fashion. When distal ends 61a of liquid lines 61 reach the electrostatic force causing an electrostatic burst due to concentration of the electrostatic force, the liquid creates the electrostatic burst.

If the electrode portion 20b is provided as described above, the liquid lines 61, (not shown), are allowed to stretch properly. This makes it possible to achieve a more stable electrostatic burst of the liquid and therefore achieve stable atomization of the liquid.

Even if the liquid adheres to the surface of the nozzle head 21, a change in action of the electrostatic force, which is made by the liquid that adheres to the surface of the nozzle head 21, makes a small impact on the nozzles 20, and stable atomization is achieved since an electric field for the electrostatic force to cause a more stable electrostatic burst is formed by the electrode portion 20b before the adhesion of the liquid.

According to the present embodiment, the electrode portion 20b has length corresponding to length of alignment of the nozzles 20. The electrode portion 20b is provided with holes 20c for the nozzles 20 to pass through. The holes 20c coincide with the nozzles 20. The holes 20c allow the electrode portion 20b to be assembled from the distal-end side of the nozzles 20.

Instead of the present embodiment in which the electrode portion 20b is configured into a single electrode portion, the electrode portion 20b may be provided to each of the plurality of nozzles 20 near the corresponding root portion on the nozzle head 21-side of the nozzle 20 protruding from the nozzle head 21. Such a configuration also provides a similar advantageous effect to the present embodiment.

### Third Embodiment

The second embodiment provides the electrode portion 20b near the root portions on the nozzle head 21-sides of the nozzles 20 made of conductive material and protruding from the nozzle head 21 made of insulating material, to thereby enhance safety of the liquid spraying. A similar advantageous effect can be achieved through shape design of the nozzles 20. The description of a third embodiment relates to a configuration in which the shape of the nozzles 20 is devised to enhance the safety of the liquid spraying.

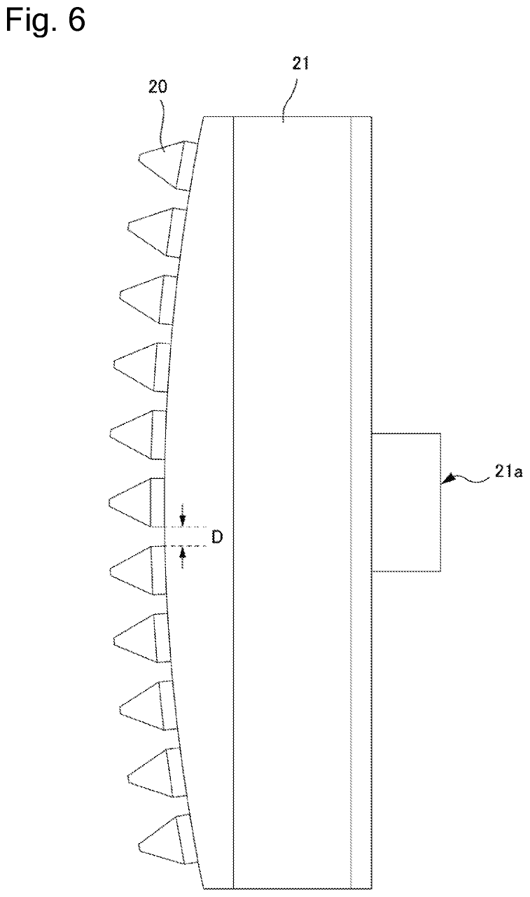

FIG. 6 is a plan view for explaining an electrostatic spraying device 10 according to the third embodiment.

FIG. 6 merely illustrates a nozzle head 21 provided with nozzles 20.

The electrostatic spraying device 10 of the third embodiment is also similar to the first embodiment in basic configuration. The following mainly discusses differences from the first embodiment and might omit a reference to similarities.

According to the first embodiment, the nozzles 20 each have a straight tube-like shape. As illustrated in FIG. 6, each of the nozzles 20 of the third embodiment is similar to the first embodiment in outer diameter of a distal end of the nozzle 20. Only a root portion on a nozzle head 21-side of the nozzle 20 protruding from the nozzle head 21 is formed larger in outer shape than a distal end portion of the nozzle 20.

According to the present embodiment, the nozzle 20 is tapered so that the outer shape thereof gradually becomes larger toward the root portion. However, the nozzle 20 does not necessarily have to be tapered. The nozzle 20 may have any shape as long as the root portion of the nozzle 20 is large enough to perform the same function as the electrode portion 20b (see FIG. 5), which is discussed under the second embodiment.

To be more specific, the nozzle 20 may have any shape as long as an electrostatic force does not concentrate and acts weakly in the root portion larger in outer diameter than the distal end of the nozzle 20 made of conductive material and has such a magnitude as not to create an electrostatic burst in the vicinity of the nozzle 20, and the liquid is subjected to a great force acting in such a direction that the liquid is pulled toward a sprayed object 30 and thus stretches frontward in a stable manner.

For example, as illustrated in FIG. 6, the outer shape of the root portion of the nozzle 20 is preferably larger than the distal end portion of the nozzle 20 so that distance D between the root portions of adjacent ones of the nozzles 20 is 5 mm or less. It is more preferable that the distance D be 3 mm or less.

As in the second embodiment, the electrostatic force acts more strongly, and the liquid further stretches frontward in a tapering fashion with increasing distance from the root portion of the nozzle 20, which is large in outer diameter. When a distal end 61a reaches the electrostatic force causing an electrostatic burst due to concentration of the electrostatic force, the liquid creates the electrostatic burst.

If large in outer shape, the root portion of the nozzle 20 has large area that contributes as an electrode. Therefore, even if the liquid adheres to a surface of the nozzle head 21, and the liquid that adheres to the surface of the nozzle head 21 behaves as an electrode in the vicinity of the root portion, a change in action of the electrostatic force, which is made by the liquid that adheres to the surface of the nozzle head 21, makes a small impact on the nozzle 20, and stable atomization is achieved due to a great contribution of the root portion of the nozzle 20 as an electrode.

In connection with the straight tube-like shape of the nozzle 20 according to the first embodiment, assuming that the outer shape of the nozzle 20 is designed large also in the distal end portion of the nozzle 20 as well as the root portion on the nozzle head 21-side of the nozzle 20 protruding from the nozzle head 21, the electrostatic force acting on the distal end portion of the nozzle 20 might become too small to properly pull the liquid. It is therefore preferable as in the present embodiment that the root portion of the nozzle 20 is designed large in outer shape without enlarging the outer shape of the distal end portion of the nozzle 20.

Such modification in the shape of the nozzles 20 makes it possible to provide the similar advantageous effect to the advantageous effect of the electrode portions 20b (see FIG. 5) discussed under the second embodiment. The stable spraying of the liquid is achieved as in the second embodiment.

### Fourth Embodiment

According to the first to third embodiments, the nozzles 20 are so disposed that the distance between the axes L of all the nozzles 20 increases as the axes L extend farther from the nozzle head 21. However, the distance between the axes L of all the nozzles 20 does not necessarily have to increase as the axes L extend farther from the nozzle head 21.

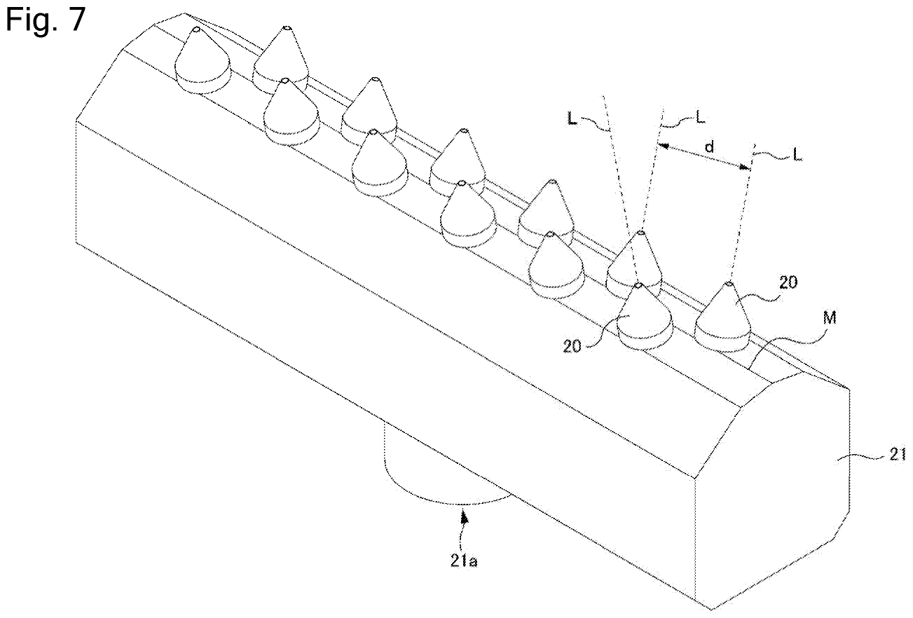

The distance needs to increase only between the axes L of adjacent nozzles 20 that make a great impact on each other. It is not necessary to increase the distance between the axes L of the nozzles 20 that are not adjacent to each other and therefore do not make any great impact on each other. The nozzles 20 may be arranged as illustrated in FIG. 7.

FIG. 7 is a perspective view for explaining an electrostatic spraying device 10 according to a fourth embodiment.

FIG. 7 merely illustrates a nozzle head 21 provided with nozzles 20.

As illustrated in FIG. 7, the fourth embodiment also provides the nozzle head 21 that has a rectangular shape as viewed straight from an object sprayed with the liquid. The nozzles 20 are aligned in a width (longitudinal) direction of the nozzle head 21.

Unlike the other embodiments, an end face of the nozzle head 21 on which the nozzles 20 are disposed is not curved. The nozzles 20 are therefore aligned in a straight line.

The nozzles 20 are arranged in a staggered pattern across a center line M extending in a thickness direction of the nozzle head 21. The nozzles 20 tilt away from the center line M so as to separate farthest from the center line M at distal ends.

If the nozzles 20 are arranged as described above, the nozzles 20 located on one side of the center line M and the nozzles 20 located on the other side of the center line M tilt in mutually opposite directions. This increases distance between the axes L of adjacent ones of the nozzles 20 with increasing distance from the nozzle head 21.

To make the adjacent ones of the nozzles 20 tilt in mutually opposite directions, the end face of the nozzle head 21 on which the nozzles 20 are disposed has inclines extending from the center line M toward a rear side of the nozzle head 21.

In a mode illustrated in FIG. 7, distance d between the axes L of alternate nozzles 20 remains constant even with increasing distance from the nozzle head 21.

It does not matter even if the distance d between the axes L remains unchanged as there is sufficient distance between alternate nozzles 20.

The fourth embodiment is similar to the first embodiment except for the configuration relating to the aforementioned arrangement of the nozzles 20.

The electrostatic spraying device 10 of the invention has been discussed on the basis of the specific embodiments. The invention, however, is not limited to the specific embodiments.

For example, it is also possible to add a proximity electrode that contributes chiefly to liquid spraying and functions as a heteropolar portion that is heteropolar to the nozzles 20, which is arranged near the nozzles 20. If such a proximity electrode is provided, an electric potential of the proximity electrode may be set to be approximately medium between an electric potential of the sprayed object 30 and an electric potential of the nozzles 20.

As explained above, the invention is not limited to the embodiments. It is apparent to a person having ordinary skill in the art from claims that proper modifications and improvements are also included in the technical range of the invention.

The entire disclosure of Japanese Patent Application No. 2016-92432 filed on May 2, 2016 including the description, claims, drawings and abstract, is incorporated herein by reference in its entirety.

### REFERENCE SIGN LIST

10: Electrostatic spraying device
20: Nozzle
20a: Distal external edge
20b: Electrode portion
20c: Hole
21: Nozzle head
21a: Liquid supply inlet
21b: Liquid outlet
21c: Liquid diverging portion
23: Electric line
30: Sprayed object
40: Voltage application device
41: One electric line
42: Other electric line
50: Earthing device
60. Taylor cone
61: Liquid line
61a: Distal end
L: Axis

1. An electrostatic spraying device which releases liquid in an electrically-charged state from a nozzle using an electrostatic force generated by voltage application and thus sprays the liquid onto a sprayed object, comprising:
a nozzle head provided with the nozzle comprising a plurality of nozzles made of conductive or semiconductive material, and
a voltage application device configured to apply voltage between the nozzles and a heteropolar portion that is heteropolar to the nozzles and thus generate the electrostatic force,
the nozzles being so disposed that distance between axes of at least adjacent nozzles increases with increasing distance from the nozzle head.

2. The electrostatic spraying device according to claim 1,
wherein the nozzles are so disposed that distance between axes of all the nozzles increases with increasing distance from the nozzle head.

3. An electrostatic spraying device which releases liquid in an electrically-charged state from a nozzle using an electrostatic force generated by voltage application and thus sprays the liquid onto a sprayed object, comprising:
a nozzle head made of insulating material, which is provided with the nozzle comprising a plurality of nozzles made of conductive or semiconductive material, and
a voltage application device configured to apply voltage between the nozzles and a heteropolar portion that is heteropolar to the nozzles and thus generate the electrostatic force,
the nozzles protruding from the nozzle head,
the electrostatic spraying device including a plurality of electrode portions that are disposed near root portions on nozzle head sides of the nozzles protruding from the nozzle head so as to coincide with the plurality of nozzles, the electrode portions having the same electric potential as the nozzles.

4. An electrostatic spraying device which releases liquid in an electrically-charged state from a nozzle using an electrostatic force generated by voltage application and thus sprays the liquid onto a sprayed object, comprising:
a nozzle head made of insulating material, which is provided with the nozzle comprising a plurality of nozzles made of conductive or semiconductive material, and
a voltage application device configured to apply voltage between the nozzles and a heteropolar portion that is heteropolar to the nozzles and thus generate the electrostatic force,
the nozzles protruding from the nozzle head,
the electrostatic spraying device including a single electrode portion that is disposed near root portions on nozzle head sides of the nozzles protruding from the nozzle head so as to coincide with all the nozzles, the electrode portion having the same electric potential as the nozzles.

5. An electrostatic spraying device which releases liquid in an electrically-charged state from a nozzle using an electrostatic force generated by voltage application and thus sprays the liquid onto a sprayed object, comprising:
a nozzle head made of insulating material, which is provided with the nozzle comprising a plurality of nozzles made of conductive or semiconductive material, and
a voltage application device configured to apply voltage between the nozzles and a heteropolar portion that is heteropolar to the nozzles and thus generate the electrostatic force,
the nozzles protruding from the nozzle head,
the nozzles including root portions on nozzle head sides of the nozzles protruding from the nozzle head, which are formed larger in outer shape than distal end portions of the nozzles.

6. The electrostatic spraying device according to claim 5,
wherein the root portions of the nozzles are formed larger in outer shape than the distal end portions of the nozzles so that distance between the root portions of adjacent ones of the nozzles is 5 mm or less.

7. The electrostatic spraying device according to claim 1,
wherein the nozzles are arranged along a width direction of the nozzle head.

8. The electrostatic spraying device according to claim 2,
wherein the nozzles are arranged along a width direction of the nozzle head.

9. The electrostatic spraying device according to claim 3,
wherein the nozzles are arranged along a width direction of the nozzle head.

10. The electrostatic spraying device according to claim 4,
wherein the nozzles are arranged along a width direction of the nozzle head.

11. The electrostatic spraying device according to claim 5,
wherein the nozzles are arranged along a width direction of the nozzle head.

12. The electrostatic spraying device according to claim 6,
wherein the nozzles are arranged along a width direction of the nozzle head.
